(19) United States
(12) Patent Application Publication
(10) Pub. No.: US 2025/0262807 A1
(43) Pub. Date: Aug. 21, 2025

(54) METHOD FOR MANUFACTURING INTEGRATED BASE

(71) Applicant: PIAO ZENG, Yangjiang (CN)

(72) Inventor: PIAO ZENG, Yangjiang (CN)

(21) Appl. No.: 18/968,018

(22) Filed: Dec. 4, 2024

Related U.S. Application Data
(63) Continuation-in-part of application No. 18/598,042, filed on Mar. 7, 2024, now Pat. No. 12,128,271.

(30) Foreign Application Priority Data
Feb. 16, 2024 (CN) 202410178859.5

(51) Int. Cl. B29C 45/14; B29K 705/00; B29L 31/52

(52) U.S. Cl. CPC B29C 45/14631; B29K 2705/00; B29L 2031/52

(57) ABSTRACT

A method for manufacturing an integrated base is provided, which includes the following steps: closing a base mold and injecting liquid plastic raw materials into the mold, maintaining pressure after injection is completed, adding materials and cooling after the pressure is maintained, opening the base mold and demolding the base after cooling to room temperature, taking out a formed base by a robotic arm. This setting overcomes a shortcoming of a complex structure of the existing treadmill base, eliminates a high production cost of welding assembly, reduces environmental pollution, and requires lower personnel skills. It has the advantages of simple assembly and low manufacturing cost.

### CROSS-REFERENCE TO RELATED APPLICATIONS

This application is a continuation-in-part of U.S. patent application Ser. No. 18/598,042, filed on Oct. 29, 2024, which claims priority to Chinese Patent Application No. 202410178859.5, filed on Feb. 16, 2024. Both of which are hereby incorporated by reference in their entireties.

### TECHNICAL FIELD

The present disclosure relates to the field of treadmill technologies, and in particular, to a method for manufacturing an integrated base.

### BACKGROUND

The existing treadmill (or walking machine) consists of a main frame as a base, a running platform installed on the main frame, handrails, and a control platform. The running platform is fixed parallel to the base, thereby forming a walking or running exercise plane.

The main frame of the existing treadmill base is usually composed of two metal crossbeams and a longitudinal beam connecting the two crossbeams, which are connected by welding technology.

An assembly process of the base connected by welding technology is complex and requires skilled welding skills from welding workers. Moreover, differences in welding levels have hindered the automation and standardization of base production.

Therefore, it is necessary to design a method for manufacturing an integrated base to solve the above problems.

### SUMMARY

The purpose of the present disclosure is to provide an integrated base with low pollution, low skill requirements for manufacturing personnel, simple assembly, and low manufacturing cost.

In order to overcome the above objection, the present disclosure uses the following technical solution for the method for manufacturing an integrated base, which includes the following steps:

S1: placing a metal member into a fixture; automatically lowering the metal member from the fixture by a robotic arm and placing it into a base mold;

S2: closing the base mold, injecting liquid plastic material into the mold, maintaining pressure after injection is completed;

S3: adding materials and cooling after the pressure is maintained;

S4: opening the base mold and demolding the base after cooling to room temperature;

S5: taking out a formed base by the robotic arm.

In an implementation mode of the present disclosure, before step S1, there is a preprocessing step: placing a reinforcement member into the fixture; automatically removing the reinforcement member from the fixture and placing it into the base mold by the robotic arm.

In an implementation mode of the present disclosure, the formed and integrated base includes support rods that are horizontally and vertically arranged and integrally formed, a rectangular base formed by the support rods; and the integrated base is provided with an installation part for a motor and a drum.

In an implementation mode of the present disclosure, the reinforcing member is provided at an axis along a length direction of the horizontally support rod and/or vertically support rod.

In an implementation mode of the present disclosure, the support rods include a top plate and two side plates, the top plate and two side plates are provided with reinforcing plates that are cross arranged, the metal member passes through an intersection point of the reinforcing plates.

In an implementation mode of the present disclosure, a bottom of the integrated base is integrally formed with a support seat.

In an implementation mode of the present disclosure, two ends of the support seat are connected with a reinforced horizontal pipe.

In an implementation mode of the present disclosure, the installation part is provided with an embedded nut.

In an implementation mode of the present disclosure, a motor fixing seat is embedded in the installation part configured to install the motor, an outside the motor fixing seat is fixedly provided with a motor support platform by a screw.

From the above technical solutions, it can be seen that the integrated base structure of the present disclosure overcomes shortcomings of a complex structure of the existing treadmill base, eliminates a high production cost of welding assembly, reduces environmental pollution, and has low skill requirements for personnel. It has the advantages of simple assembly and low manufacturing cost.

### BRIEF DESCRIPTION OF DRAWINGS

FIG. 1 is a schematic diagram of an integrated base of the present disclosure.

FIG. 2 is a partial enlarged view of the integrated base of the present disclosure.

FIG. 3 is a schematic diagram of a treadmill with the integrated base of the present disclosure.

FIG. 4 is an exploded view of the treadmill with the integrated base of the present disclosure.

FIG. 5 is a sectional view of the treadmill with the integrated base of the present disclosure.

FIG. 6 is an installation schematic diagram of a drum of the treadmill with the integrated base of the present disclosure.

FIG. 7 is a schematic diagram of a motor support platform of the treadmill with the integrated base of the present disclosure.

### DESCRIPTION OF EMBODIMENTS

In order to clarify the purpose, technical solution, and advantages of the present disclosure, a detailed description of the present disclosure will be provided below in combination with the drawings and specific embodiments.

The present disclosure provides a method for manufacturing an integrated base, including the following steps:

S1: placing a metal member into a fixture; automatically lowering the metal member from the fixture by a robotic arm and placing it into a base mold;

S2: closing the base mold, injecting liquid plastic material into the mold, maintaining pressure after injection is completed;

S3: adding materials and cooling after the pressure is maintained;

S4: opening the base mold and demolding the base after cooling to room temperature;

S5: taking out a formed base by the robotic arm

In an implementation mode: before S1, there is also a preprocessing step: placing a reinforcement member into the fixture; automatically removing the reinforcement component from the fixture and placing it into the base mold by the robotic arm. The reinforcement member can be made of metal materials or other non-metallic materials with strength, such as engineering plastics. On the one hand, the reinforcement member can increase the strength of the formed base, and on the other hand, it can also facilitate the formation of the integrated base and accelerate a forming speed.

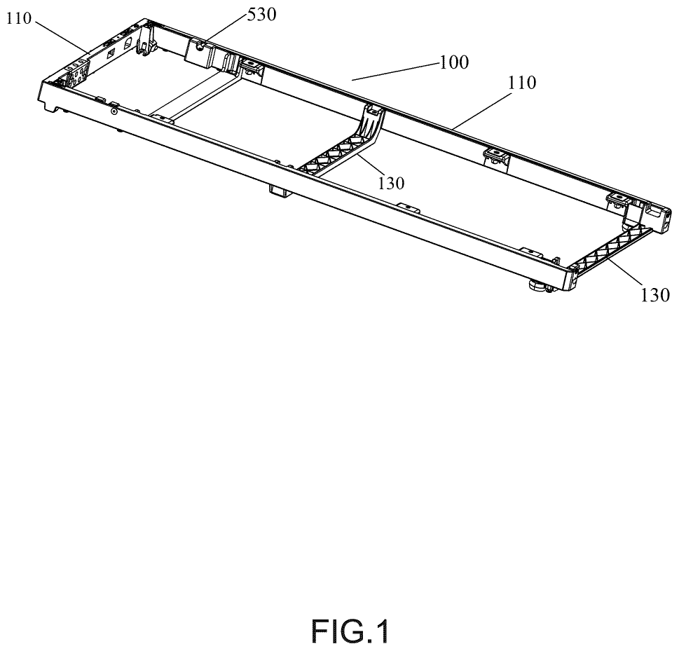

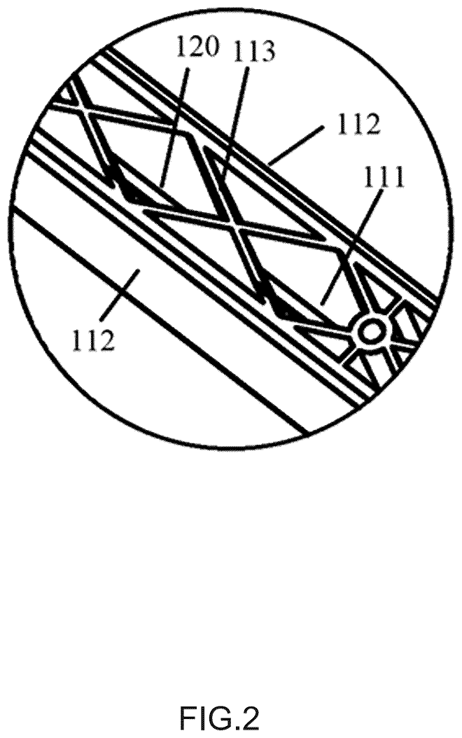

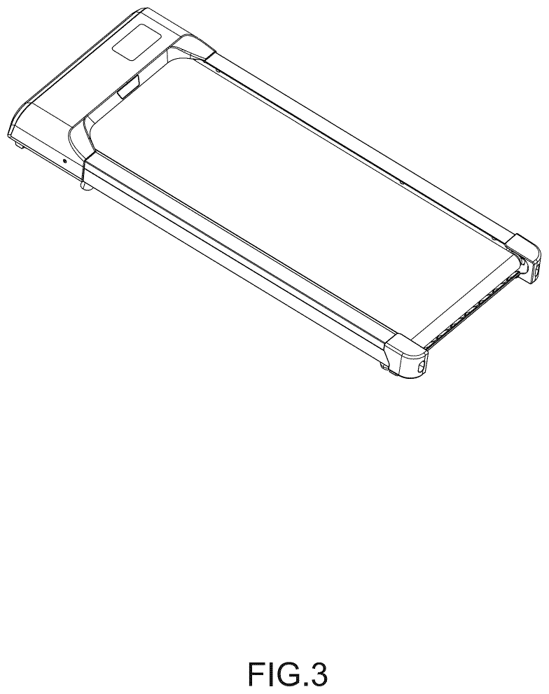

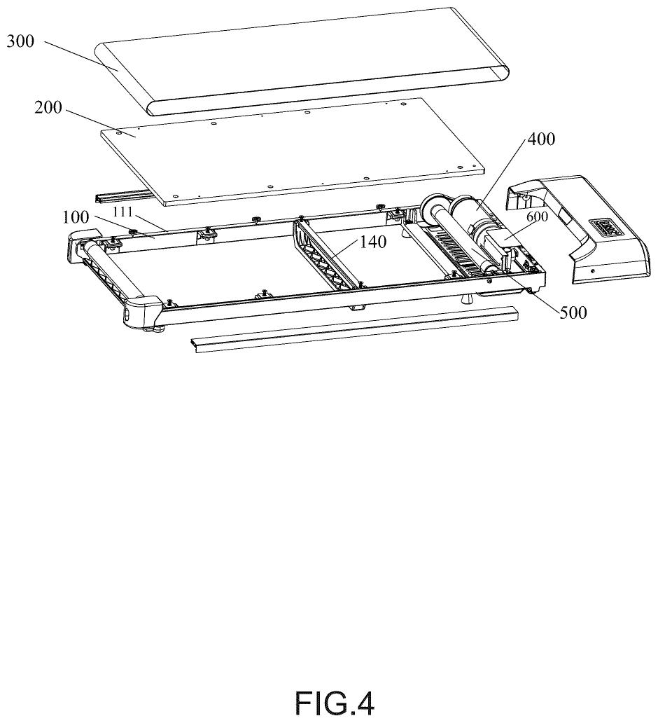

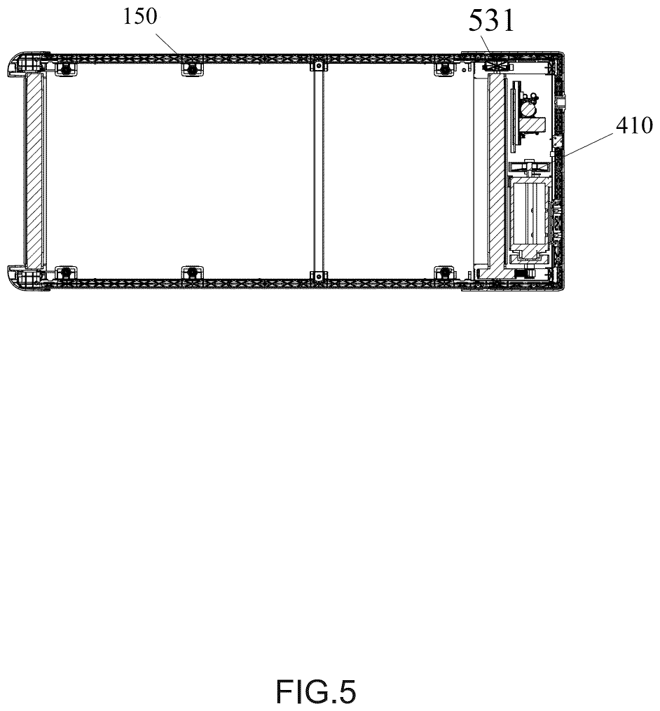

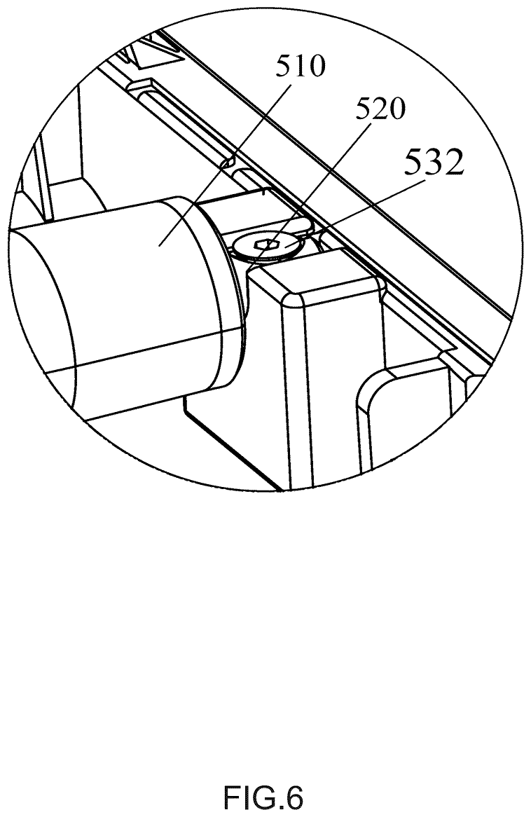

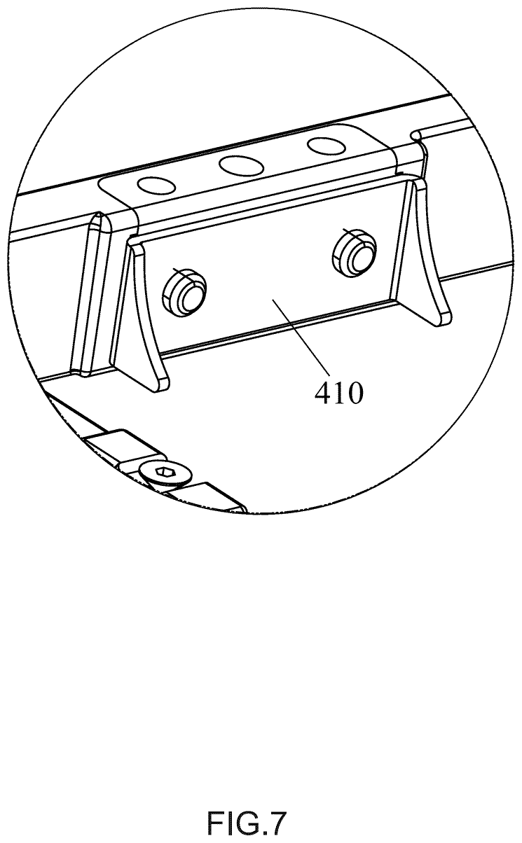

Please refer to FIGS. 1-7, a treadmill with an integrated base includes an integrated base 100, a running board 200, a running belt 300, an electric motor 400, an electric control 600, and a drum 500. The integrated base 100 includes support rods 110 that are horizontally and longitudinally arranged and integrally formed, the support rods 110 are enclosed to form a rectangular base 100. It can be understood that according to a length, the support rods 110 can be divided into a long support rod and a short support rod. The integrated base 100 is provided with an installation part for the electric motor 400 and the drum 500, rendering it easy to assemble into a complete treadmill. The integrated base overcomes drawbacks of a complex structure of existing treadmill bases, eliminates a high production cost of welding assembly, reduces environmental pollution, and has low skill requirements for personnel. It has advantages of simple assembly and low manufacturing cost. It can be understood that the integrated base can also be applied to a walker with similar functions.

In this embodiment, the reinforcing member 120 is provided at an axis of the transverse and/or longitudinal support rod 110 along its length direction. The reinforcing member 120 increases support strength of the support rods 120 and can avoid significant deformation of the support rods 110 under pressure.

In this embodiment, the support rod 110 includes a top plate 111 and two side plates 112. The top plate 111 and the two side plates 112 are provided with reinforcing plates 113 that are cross arranged, the metal member 120 passes through an intersection point of the reinforcing plates 113. The reinforcement plates 113 allow the support rods 110 to use fewer manufacturing materials to save costs while maintaining the same support strength, and it is also more convenient for injection molding.

In this embodiment, a bottom of the base 100 is integrally formed with a support seat 130. It can be understood that the support seat 130 is provided between two parallel support rods 110 with a longer length, which can avoid a problem of insufficient support strength in the middle of the support rod 110 due to the length being too long.

In this embodiment, two ends of the support seat 130 are connected with a reinforced horizontal pipe 140 to increase the support strength of the integrated base 100.

In this embodiment, the installation part is provided with an embedded nut 150. It can be understood that the integrated base 100 is manufactured using injection molding technology, and the embedded nut 150 is embedded during an injection molding process, simplifying an assembly process, and avoiding a possibility of inaccurate alignment during assembly.

In this embodiment, the drum 500 includes a rotating body 510 and a rotating shaft 520. The installation part configured to assemble the drum 500 is provided with an arc-shaped groove 530 configured to embed the rotating shaft 520. The arc-shaped groove 530 is provided with a threaded hole 531 corresponding to the rotating shaft. The rotating shaft is fixedly connected to the integrated base by a screw 532 to facilitate modular assembly of the treadmill.

In this embodiment, the installation part configured to install the motor 200 is embedded with a motor fixing seat 410, an outside of the motor fixing seat 410 is fixedly provided with a motor support platform 210 by the screw 532 to support and reduce vibration of the motor.

Terms used in this specification, such as “up”, “down”, “front”, “back”, etc., to represent spatial relative positions are for a purpose of illustration to describe the relationship between one feature and another as shown in the drawings. It can be understood that depending on the placement of the product, the term relative spatial position can be intended to include different orientations other than those shown in the drawings, and should not be understood as a limitation on the claims.

In addition, the above embodiments are only used to illustrate the present disclosure and not to limit the technical solutions described herein. The understanding of this specification should be based on those skilled in the art. Although this specification has provided detailed explanations of the present disclosure with reference to the above embodiments, those skilled in the art should understand that, technicians in the relevant technical field can still modify or replace the present disclosure, and all technical solutions and improvements that do not deviate from the spirit and scope of the present disclosure should be covered within the scope of the claims of the present disclosure.

What is claimed is:

1. A method for manufacturing an integrated base, comprising the following steps:
S1: placing a metal member into a fixture; automatically lowering the metal member from the fixture by a robotic arm and placing it into a base mold;
S2: closing the base mold, injecting liquid plastic material into the mold, maintaining pressure after injection is completed;
S3: adding materials and cooling after the pressure is maintained;
S4: opening the base mold and demolding the base after cooling to room temperature;
S5: taking out a formed base by the robotic arm.

2. The method for manufacturing an integrated base according to claim 1, wherein before step S1, there is a preprocessing step: placing a reinforcement member into the fixture;
automatically removing the reinforcement member from the fixture and placing it into the base mold by the robotic arm.

3. The method for manufacturing an integrated base according to claim 1, wherein the formed and integrated base comprises support rods that are horizontally and vertically arranged and integrally formed, a rectangular base formed by the support rods; and the integrated base is provided with an installation part for a motor and a drum.

4. The method for manufacturing an integrated base according to claim 2, wherein the reinforcing member is provided at an axis along a length direction of the horizontally support rod and/or vertically support rod.

5. The method for manufacturing an integrated base according to claim 3, wherein the support rods comprise a top plate and two side plates, the top plate and two side plates are provided with reinforcing plates that are cross arranged, the metal member passes through an intersection point of the reinforcing plates.

6. The method for manufacturing an integrated base according to claim 5, wherein a bottom of the integrated base is integrally formed with a support seat.

7. The method for manufacturing an integrated base according to claim 6, wherein two ends of the support seat are connected with a reinforced horizontal pipe.

8. The method for manufacturing an integrated base according to claim 3, wherein the installation part is provided with an embedded nut.

9. The method for manufacturing an integrated base according to claim 3, a motor fixing seat is embedded in the installation part configured to install the motor, an outside the motor fixing seat is fixedly provided with a motor support platform by a screw.
